(19) United States
(12) Patent Application Publication
(10) Pub. No.: US 2017/0057859 A1
(43) Pub. Date: Mar. 2, 2017

(54) METHOD FOR THE AUTOMATED PRODUCTION OF A GLASS BODY COMPRISING A DIAPHRAGM

(71) Applicant: Endress+Hauser Conducta GmbH+Co.KG, Gerlingen (DE)

(72) Inventors: JENS VOIGTLÄNDER, Waldheim (DE); NADINE FIEDLER, Waldheim (DE); CARSTEN ENDERWITZ, Waldheim (DE); SANDRA BLUME, Meinsberg (DE)

(21) Appl. No.: 15/244,453

(22) Filed: Aug. 23, 2016

(30) Foreign Application Priority Data
Aug. 28, 2015 (DE) 10 2015 114 329.1
Dec. 10, 2015 (DE) 10 2015 121 503.9

(51) Int. Cl. C03B 23/207; G01N 27/416; C03B 33/085

(52) U.S. Cl. CPC C03B 23/207; C03B 33/0855; G01N 27/4167

(57) ABSTRACT

One aspect of the present disclosure relates to a method for the automated production of a glass body comprising a diaphragm for a potentiometric sensor. The method includes providing a glass assembly, which includes an outer tube and at least one inner tube running inside the outer tube, wherein the inner tube and the outer tube are arranged coaxially and wherein one end of the inner tube is substance-to-substance bonded to a tube wall of the outer tube; forming at least one aperture through the tube wall of the outer tube; introducing a porous diaphragm body into the aperture, the diaphragm body including a coating of glass in at least one section; and creating a substance-to-substance bond between the tube wall of the outer tube and at least the section of the diaphragm body comprising the coating of glass.

### CROSS-REFERENCE TO RELATED APPLICATIONS

The present application is related to and claims the priority benefit of German Patent Application No. 10 2015 114 329.1, filed on Aug. 28, 2015 and German Patent Application No. 10 2015 121 503.9, filed on Dec. 10, 2015, the entire contents of which are incorporated herein by reference.

### TECHNICAL FIELD

The present disclosure relates to a method for the automated production of a glass body comprising a diaphragm for a potentiometric sensor—in particular, for a pH sensor or another ion-sensitive sensor.

### BACKGROUND

A conventional potentiometric sensor for detecting a measurement of a measuring fluid, such as a pH sensor for detecting the pH value of a measuring fluid, comprises a glass body with two glass tubes arranged coaxially to one another, wherein the outer glass tube is connected at one end to the inner glass tube, so that the outer glass tube is closed at this end. In a pH sensor with a glass electrode, the inner glass tube is closed at this end with a pH-sensitive glass membrane. The end section of the sensor that comprises the connection point of the inner glass tube with the outer glass tube and, in the case of a pH sensor with a glass electrode, the glass membrane, is designed to be brought into contact with the measuring fluid—by immersion, for example. This end section of the glass body comprises at least one diaphragm, via which an electrochemical connection is ensured between a reference electrode, which is arranged in the chamber formed between the outer glass tube and the inner glass tube, and a medium surrounding the sensor.

Conventionally, the production of such glass bodies requires a lot of manual labor and is very time-consuming. EP 1 692 080 B1 describes a method for the automated production of a glass body for potentiometric pH sensors. The method comprises the loading of a first spindle of a glass lathe with an outer glass tube and an inner glass tube, wherein the outer glass tube and the inner glass tube are arranged coaxially to one another and to an axis of rotation of the first spindle of the glass lathe, the inner glass tube and the outer glass tube each exhibit an end on the medium side, and the two medium-side ends are positioned at a defined axial position toward one another; the loading of a second spindle with an auxiliary glass tube, wherein the axis of rotation of the second spindle is coaxially arranged to the axis of rotation of the first spindle; the approach of the auxiliary glass tube to the outer glass tube; the fusion of the outer glass tube with the auxiliary glass tube; the creation of a connection between the outer glass tube or the auxiliary glass tube and the inner glass tube; the removal of the remains of the auxiliary glass tube; the creation of a medium-side opening of the inner glass tube; and the formation of a medium-side edge of the opening.

In the method described in EP 1692 080 B1, the outer glass tube may comprise a ceramic diaphragm in its medium-side end section, which diaphragm may be fused with the medium-side front face and which diaphragm is integrated, by fusing the medium-side end of the outer glass tube with the inner glass tube, into the outer tube of the glass body thus formed. The fixation of the diaphragm to a front face of the outer glass tube is thus a step that is upstream of the automated production method for the glass body, which, on the one hand, requires time and, on the other, a certain amount of logistical effort, in order to ensure that all of the outer glass tubes inserted into the spindle of the glass lathe are provided with a diaphragm that also meets the desired production tolerances.

### BRIEF SUMMARY OF THE INVENTION

It is now the object of the present disclosure to provide a method for the automated production of a glass body that comprises a diaphragm and overcomes the disadvantages of the prior art. This object is solved by the method according to claim 1 and the device according to claim 13. Advantageous embodiments are specified in the dependent claims.

The method according to the present disclosure for the automated production of a glass body comprising a diaphragm for a potentiometric sensor comprises providing a glass assembly, which comprises an outer tube and at least one inner tube running inside the outer tube, wherein the inner tube and the outer tube are arranged coaxially and wherein one end of the inner tube is sub stance-to-substance bonded to—in particular, fused with—a tube wall of the outer tube; producing at least one aperture running through the tube wall of the outer tube; positioning a porous diaphragm body, which comprises a coating of glass in at least one section, into the aperture; and creating a substance-to-substance bond between the tube wall of the outer tube and at least the section of the diaphragm body comprising the coating of glass. The diaphragm body preferably consists of a porous ceramic. The coating of glass is preferably closely connected or connected in a gap-free manner with the diaphragm body. All the steps described are preferably carried out automatically.

By introducing the diaphragm body into an aperture in the tube wall of the outer tube and by creating a substance-to-substance bond between the tube wall and the glass coating facilitating the substance-to-substance bond between the tube wall and the diaphragm body, the step of introducing the diaphragm into the glass assembly can be carried out in an automated manner together with further steps for the automated production of the glass assembly. It is not necessary to prepare the outer tube for the automated production of the glass assembly by affixing the diaphragm prior to loading the outer tube into a machine.

The substance-to-substance bond between the tube wall of the outer tube and the section of the diaphragm body comprising the coating may be produced by fusing the tube wall of the outer tube with the diaphragm body—in particular, by fusing the tube wall with the coating of glass of the diaphragm body.

In at least one embodiment, the glass assembly is arranged in a workpiece holder of a spindle of a lathe that can be rotated about an axis of rotation, so that the tube axis of the inner tube and the tube axis of the outer tube coincide with the axis of rotation, and wherein, in order to create the at least one aperture through the tube wall of the outer tube and to produce the substance-to-substance bond between the tube wall of the outer tube and the ceramic body, one or more gas burners and/or lasers are used, which are fixed on a tool slide that can be moved relative—in particular, orthogonally—to the axis of rotation of the spindle. The tool slide and the burner holder or laser holder arranged thereon are advantageously aligned orthogonally to the axis of rotation.

The step of creating the aperture running through the tube wall of the outer tube may comprise the following steps: local heating—in particular, melting—of the tube wall of the outer tube by means of a first gas burner or laser; and applying an overpressure in a space enclosed between the inner tube and the outer tube. The overpressure in the space enclosed between the inner tube and the outer tube causes the locally heated or locally melted region of the tube wall to burst, so that an aperture through the tube wall of the outer tube is formed.

The step of introducing the porous ceramic body into the aperture may comprise the following steps: automatic holding of at least one diaphragm body by means of a holding device arranged, in particular, on a second tool slide that is movable relative to the glass assembly held in the workpiece holder; and inserting the diaphragm body into the aperture by means of the holding device, wherein the holding device and the glass assembly are moved relative to each other in order to insert the diaphragm body into the aperture.

The step of creating a substance-to-substance bond between the tube wall of the outer tube and at least the section of the diaphragm body comprising the coating of glass may include the fusion of the coating of glass by means of a heat source—for example, by means of a burner flame or by means of a laser beam guided around the diaphragm body inserted into the aperture. The glass assembly may comprise two inner tubes arranged coaxially, one behind the other, in the outer tube, wherein the inner tubes are substance-to-substance bonded to—in particular, fused with—the outer tube at their end facing the respective other inner tube. The ends of the outer tube may be held respectively by a workpiece holder of rotatable spindles of a lathe that are opposite each other, wherein the inner tubes are connected to the outer tube at a region of the outer tube that is arranged centrally between the ends of the outer tube.

A first inner tube of the two inner tubes may be connected to the outer tube at a first connection point, wherein a second—viz., the other—inner tube is connected to the outer tube at a second connection point that is axially spaced apart from the first connection point with respect to the axis of rotation of the outer tube, and wherein the creation of at least one aperture running through the tube wall of the outer tube, the introducing of the diaphragm body into the opening, and the creation of a substance-to-substance bond between the diaphragm body and the tube wall of the outer tube are carried out simultaneously at a first position in the wall of the outer tube, which is arranged between the first connection point and the first end of the outer tube located on the side of the first connection point facing away from the second connection point, and at a second position in the wall of the outer tube, which is arranged between the second connection point and the second end of the outer tube located on the side of the second connection point facing away from the first connection point.

Between the first connection point and the first end of the outer tube, several apertures may be created, a diaphragm body positioned into each aperture, and a substance-to-substance bond each created between the diaphragm bodies and the tube wall of the outer tube, wherein the same number of apertures is created between the second connection point and the second end of the outer tube, a diaphragm body positioned into each aperture, and a substance-to-substance bond each created between the diaphragm bodies and the tube wall of the outer tube, as between the first connection point and the first end of the outer tube.

After connecting all diaphragm bodies to the tube wall of the outer tube, the glass assembly may be divided into two separate glass bodies by means of a heat source, such as a dividing flame or a laser beam, that acts on the outer tube at a point arranged between the ends of the inner tubes connected to the outer tube. In this way, two glass bodies, which may each be further processed into a potentiometric sensor, may be produced simultaneously in an automated manner and provided respectively with one or more diaphragms.

The method may be carried out by means of an automatic controller, in particular an electronic controller comprising a processor which is designed to control a drive of a rotational movement of the spindle, one or more drives of the tool slide, and/or one or more gas burners or lasers, and/or one or more drives of the holding device. The controller can comprise software comprising algorithms for this control task.

The present disclosure also relates to a device for the automated production of a glass body comprising a diaphragm for a potentiometric sensor—in particular, in accordance with the method described above. The device comprises: a lathe with at least one spindle that is rotatable about an axis of rotation and that comprises a workpiece holder; one or more gas burners and/or lasers fixed on a first tool slide that can be moved relative—in particular, orthogonally—to the axis of rotation of the spindle; one or more drives for driving a rotational movement of the spindle and a movement of the first tool slide; a controller that is designed to control the burners and/or lasers and the one or more drives to carry out the method—in particular, in accordance with one of the method variants described above.

In at least one embodiment, the device further comprises a holding device, which is designed to automatically hold one or more diaphragm bodies from a supply of similar diaphragm bodies and which is arranged—in particular, on a second tool slide—so as to be movable relative to the axis of rotation of the rotatable spindle of the lathe, wherein the controller is designed to control the movement of the holding device.

In an embodiment that allows for the simultaneous production of two glass bodies that may each be further processed into a potentiometric sensor, the device comprises a second spindle that is rotatable about the axis of rotation and that comprises an additional workpiece holder, wherein the workpiece holders are arranged so that they are opposite each other.

### BRIEF DESCRIPTION OF THE DRAWINGS

In the following, the present disclosure is explained in further detail on the basis of the exemplary embodiments shown in the figures. The figures show:

FIG. 1 shows a diaphragm body according to exemplary embodiments of the present disclosure;

FIGS. 2A and 2B show a section of a tube wall of an outer tube of a glass assembly with an aperture, into which a diaphragm body according to FIG. 1 is inserted and substance-to-substance bonded to the wall tube of the outer tube according to exemplary embodiments of the present disclosure;

FIG. 3 shows a glass body for a potentiometric sensor with an outer tube, in the tube wall of which two diaphragms are arranged according to exemplary embodiments of the present disclosure;

FIG. 4A shows a forming of two apertures in one wall of an outer tube of a glass assembly according to exemplary embodiments of the present disclosure;

FIG. 4B shows a introducing of a diaphragm body in each aperture in the wall of an outer tube according to exemplary embodiments of the present disclosure;

FIG. 4C shows a fusing of diaphragm bodies positioned into apertures of a wall of an outer tube with the wall of the outer tube according to exemplary embodiments of the present disclosure; and

FIG. 4D shows a division of a glass assembly into two separate glass bodies according to exemplary embodiments of the present disclosure.

### DETAILED DESCRIPTION

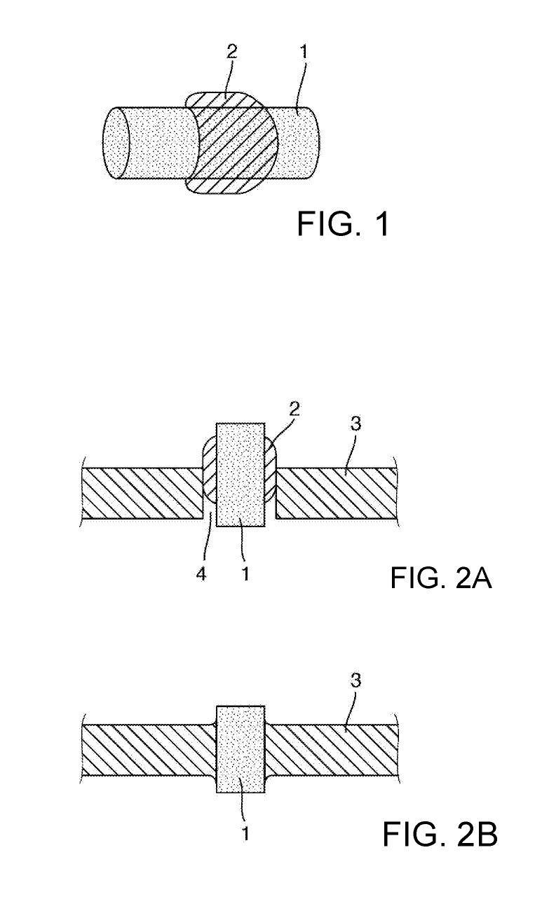

FIG. 1 schematically shows a cylindrical diaphragm body 1 that is made of a porous ceramic and comprises a coating 2 of glass in a central section. The glass coating is closely connected in a gap-free manner to the surface of the diaphragm body 1.

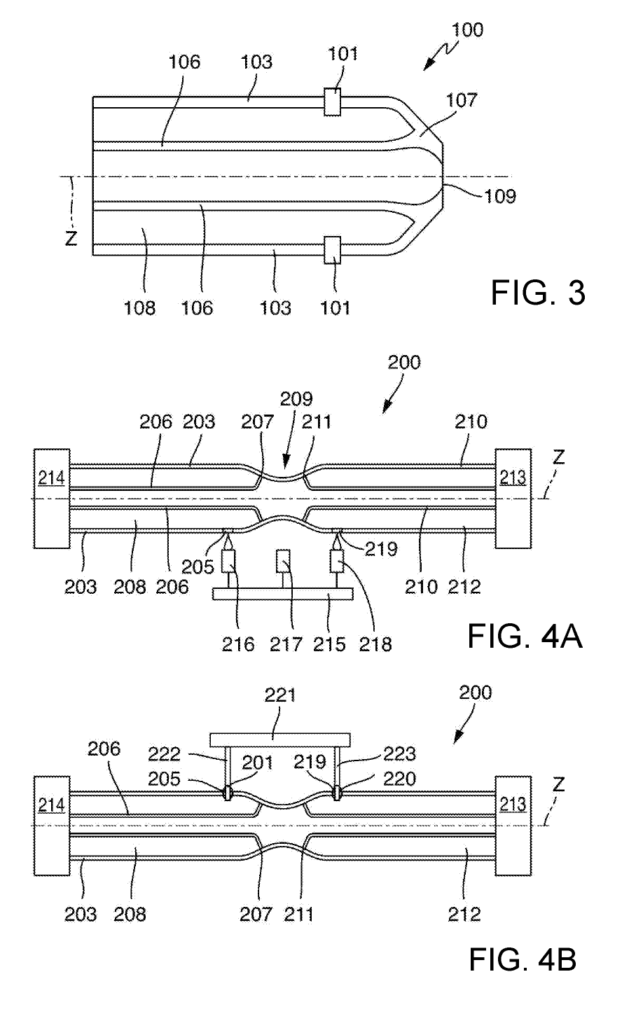

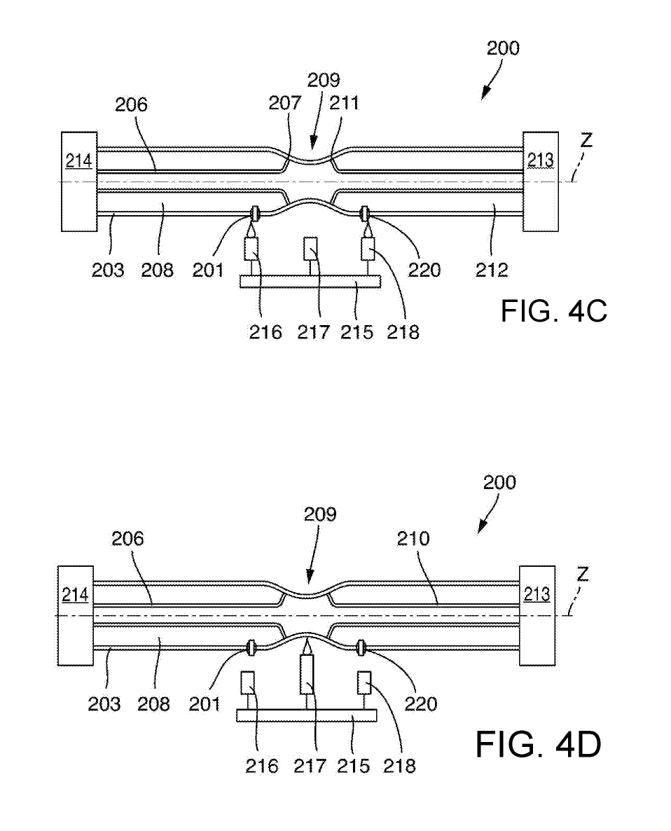

FIG. 2A schematically shows a section of a wall of a glass tube 3 that could be an outer tube of a glass assembly for a potentiometric sensor, as described in more detail below in connection with FIGS. 3 and 4. The wall of the glass tube 3 includes an aperture 4 with a circular cross section. The diaphragm body 1 with the coating 2 of glass as shown in FIG. 1 is introduced into the aperture 4.

A substance-to-substance bond between the diaphragm body 1 and the wall of the glass tube 3 may be created by melting by means of a gas burner. The melting is facilitated by the glass coating of the diaphragm body 1. For this purpose, a heat source—in the present example a gas burner flame—is guided circularly around the diaphragm body 1 in order to connect the glass coating with the glass wall of the glass tube 3. Alternatively, a laser beam may also be used. FIG. 2B shows the diaphragm body 1 substance-to-substance bonded in this manner to the wall of the glass tube 3. The diaphragm body 1 now forms a diaphragm serving as an electrochemical bridge between a medium contained within the glass tube 3 and a medium located outside the glass tube 3.

FIG. 3 schematically shows a glass body 100 for a potentiometric sensor. The glass body 100 comprises an inner tube 106 and an outer tube 103, which are arranged coaxially with respect to their common cylinder axis Z. In a tube wall of the outer tube 103, two diaphragms 101 are arranged and are substance-to-substance bonded to the tube wall of the outer tube 103 by melting them into the tube wall. The diaphragms 101 are each formed as a cylindrical porous ceramic body.

At a connection point 107, the inner tube 106 and the outer tube 103 are fused together. The connection point 107 closes one end of an annular chamber 108 formed between the inner tube 106 and the outer tube 103. The inner tube 106 is open at its end 109 located in the region of the connection point 107.

The connection of the inner tube 106 to the outer tube 103 and the formation of the end region of the glass body, which comprises the connection point, with the opening of the inner tube 106 at its end 109 may, for example, be carried out in an automated manner, in accordance with the method described in EP 1692 080 B1. Subsequently, openings, into each of which the diaphragm body 101 may be inserted and fused into the tube wall, as described based upon FIGS. 2A and 2B, may be created in the wall of the outer tube 103.

The introduction of the diaphragms 101 may also be carried out in an automated manner. For this purpose, a glass assembly that is not yet provided with diaphragms and consists of the outer tube 103 and the inner tube 106 that is connected thereto at the connection point 107 and whose end 109 is open, is inserted into a workpiece holder arranged on a rotatable spindle of a lathe. In doing so, the axis of rotation, about which the spindle can be rotated, and the common cylinder axis Z of the inner tube 106 and the outer tube 103 coincide. The annular chamber 108 of the glass assembly, which is arranged between the inner tube 106 and the outer tube 103, is connected to a gas supply line, via which air, nitrogen, or an inert gas or an inert gas mixture, for example, can be blown into the annular chamber under pressure.

The lathe further comprises a first tool slide, on which a gas burner arrangement with one or more gas burners is arranged so as to be movable in a direction parallel and/or orthogonal to the axis of rotation of the spindle. In the example described here, all processing steps that comprise the effect of a heat source on the glass workpieces to be processed are carried out by means of gas burners. Alternatively, it is also possible to use a laser beam as the heat source. In this case, lasers are used instead of the gas burners. It is also possible to combine lasers and gas burners. The lathe comprises a second tool slide on which a gripper tool is arranged that is movable relative to the axis of rotation of the spindle and can grasp and transport one or more diaphragm bodies like those shown in FIG. 1 from a diaphragm body supply. The gas burners, the movement of the first and the second tool slides, of the gas burners and of the gripper tool, the rotation of the spindle, and the gas supply line into the annular chamber 108 are controlled by means of an automatic controller in accordance with a defined operating program.

In order to control the gas burners, the controller on the one hand controls the gas mixture that is supplied to the gas burners, an ignition device, and the position of the burners and their angles with respect to the axis of rotation of the spindle. The temperature of the glass regions to be processed is an essential criterion for the control and/or regulation of the gas burners; it is measured by means of a pyrometer whose measured values are captured and processed by the controller. The processing temperature may, for example, be between 800° C. and 900° C.

In order to control the introduction of gas into the annular chamber 108, a pressure sensor may be provided, which detects the pressure in the gas supply line connected to the annular chamber 108 and outputs measured values to the controller, which processes them and uses them to control the gas pressure in the annular chamber. The end of the glass assembly or the annular chamber 108 facing away from the connection point 107 is preferably closed in a pressure-tight manner during the process.

In order to create an opening in the wall of the outer tube 103, the wall of the outer tube is heated locally by means of a gas burner. Simultaneously, an overpressure is created in the annular chamber 108 via the gas supply line. This results in the forming of an opening, through-hole, or aperture in the heated region. In the process, the flame of the gas burner and the applied overpressure are controlled in such a way that the diameter of the aperture is between 1 and 2 mm. This may of course be adjusted to other diaphragm sizes, depending upon the requirements of the sensor to be produced. In this way, one or more apertures—in the present example, two apertures—may be created in the wall of the outer tube 103.

Subsequently, a diaphragm body that corresponds to the diaphragm body shown in FIG. 1 is taken from a supply by the gripper tool and preheated by means of a gas burner flame. The preheated diaphragm body is then fixed by the action of a burner flame in an aperture created in the glass wall, cf. FIG. 2A. Subsequently, the diaphragm body is fused with the wall of the outer tube by means of a directional oxygen-hydrogen flame of a gas burner moved circularly along the perimeter of the diaphragm body, and, in this way, a diaphragm 101 substance-to-substance and gap-free bonded to the glass wall is created. This is repeated for each additional aperture created in the wall of the outer tube.

The glass body 100 produced in this way may be further processed in order to produce a potentiometric sensor, such as a pH sensor. The production of a pH sensor with a glass electrode made of the glass body 100 may, for example, be carried out in the following manner. For example, the glass body 100 may be processed further to produce a pH sensor with a glass electrode by blowing a pH-sensitive glass membrane onto the open front end 109 of the inner tube 106, by introducing a buffer solution and a potential discharger into the inner tube 106, and by introducing a reference electrolyte and a reference electrode into the chamber 108 formed between the inner tube 106 and the outer tube 103. The glass body 100 may then be closed on the rear side, wherein the reference electrode and the potential discharger are conducted to a contact point that is arranged outside the chambers that are formed in the glass body 100 and filled with electrolyte. The contact point may be connected to a measuring circuit, which may be arranged in an electronic housing that is connected firmly at the rear side to the glass body 100 and that may be designed, for example, as a plug head.

FIGS. 4A-4D schematically show the process of a method in which two glass bodies, each with an outer tube and an inner tube and a diaphragm arranged in the wall of the outer tube, may be simultaneously produced in an automated manner.

In a first step (FIG. 4A), a glass assembly 200 is loaded into two tool holders of spindles 213, 214 of a lathe, which are opposite each other and rotatable about a common axis of rotation Z. The glass assembly 200 comprises an outer tube 203 and a first inner tube 206, as well as a second inner tube 210, which are arranged coaxially with respect to a common axis of rotation that coincides with the axis of rotation Z of the spindles 213, 214. The inner tubes 206, 210 respectively comprise at ends facing each other a circular or disk-shaped radial expansion that is fused with the outer tube in a central region—hereafter also called processing center point 209—at connection points 207, 211 opposite each other. The first annular chamber 208 formed between the first inner tube 206 and the outer tube 203 and the second annular chamber 212 formed between the second inner tube 210 and the outer tube 203 are respectively connected to a gas supply line (not shown), by means of which a gas pressure in the annular chambers 208 and 212 can be adjusted.

The lathe comprises a first tool slide 215 and gas burners 216, 217, 218 that are arranged thereon and that, by means of the tool slide and/or a burner support possibly arranged on the tool slide, can be moved relative to the axis of rotation Z or to the glass assembly 200 loaded into the spindles 213, 214. In this exemplary embodiment, it is also possible to use lasers as an alternative to one or all gas burners 216, 217, 218 for the processing of the glass workpieces.

The lathe further comprises a controller (not shown) that controls drives of the spindles 213, 214, a drive of the tool slide 215, the gas pressure in the annular chambers 208, 212, and the burners 216, 217, 218, in order to carry out the method described here in accordance with a defined operating program. In order to control and/or regulate the gas pressure, the controller uses, in the exact same manner as described previously based upon FIG. 3, measured values of one or more pressure sensors that detect the pressure prevailing in the annular chambers 208, 212. In order to control and/or regulate the gas burners, the controller uses measured values of one or more pyrometers that measure the temperature of the regions of the glass assembly heated by means of the gas burners. All steps described in the following are carried out in an automated manner in the present example by means of the controller.

In order to create apertures in the wall of the outer tube 203, two gas burners 216, 218 are respectively approximated to a position on the exterior of the outer tube 203, which has a distance of about 10 mm to the processing center point 209. By means of the gas burners 216, 218, the outer tube 203 is locally heated at these positions. At the same time, the pressure in the annular chambers 208, 212 is increased, so that when the tube wall softens in the heated region, apertures 205 that have a diameter of about 1 to 2 mm form in the tube wall.

In a second step (FIG. 4B), two porous diaphragm bodies 201, which comprise at least in sections a coating of glass, are inserted into the apertures 205, 219. For this purpose, the lathe comprises a second tool slide 221, on which two gripper tools 222 and 223 are arranged, which are arranged so that they can be moved by means of the tool slide 221 relative to the glass assembly 200 arranged in the spindles 213, 214. The controller is also designed to control the movement of the second tool slide 221 and/or the gripper tools 222 and 223.

The gripper tools 222, 223 grip two diaphragm bodies 201, 220 from a supply of diaphragm bodies that are designed in the same manner as the diaphragm body 1 shown in FIG. 1. The gripped diaphragm bodies 201, 220 are preheated by means of a gas burner arranged on the first tool slide 215 and inserted into the apertures 205 and 219 in the wall of the outer tube 203. For this purpose, the glass assembly can be rotated toward the second tool slide 221 by means of the spindles 213, 214.

In a third step (FIG. 4C), the diaphragm bodies 201, 220 inserted into the apertures 205 and 219 are fused with the wall of the outer tube 203 by means of two gas burner flames 216, 218 that are guided circularly around the respective diaphragm body 201, 220.

In a last step (FIG. 4D), the glass assembly 200 is set into rotation by means of the spindles 213, 214, and a gas flame is directed toward the processing center point 209 by means of an additional gas burner 217. By locally heating and pulling apart the two ends of the glass assembly, it is divided into two individual glass bodies corresponding to the glass body 100 shown in FIG. 3.

Claimed is:

1. A method for the automated production of a glass body of a sensor, the method comprising:
providing a glass assembly that includes an outer tube and at least one inner tube disposed within the outer tube, wherein the inner tube and the outer tube are arranged coaxially and wherein one end of the inner tube is substance-to-substance bonded to a tube wall of the outer tube;
forming an aperture through the tube wall of the outer tube;
introducing a porous diaphragm body into the aperture, at least one portion of the diaphragm body including a coating of glass; and
creating a substance-to-substance bond between the tube wall of the outer tube and at least the portion of the diaphragm body with the coating of glass.

2. The method of claim 1, wherein the step of creating the substance-to-substance bond between the tube wall of the outer tube and the diaphragm body includes fusing the tube wall with at least the portion of the diaphragm body with the coating of glass by means of a heat source.

3. The method of claim 1, wherein the glass assembly is arranged in a workpiece holder of a spindle of a lathe that can be rotated about an axis of rotation, such that an inner tube axis of the inner tube and an outer tube axis of the outer tube coincide with the axis of rotation, and
wherein a heat source is used to form the aperture through the tube wall of the outer tube and to produce the substance-to-substance bond between the tube wall of the outer tube and the diaphragm body, wherein the heat source is fixed on a first tool slide that is moveable relative to the axis of rotation of the spindle.

4. The method of claim 3, wherein the heat source is a burner flame or a laser beam guided around the diaphragm body introduced into the aperture.

5. The method of claim 3, wherein the step of introducing the diaphragm body into the aperture comprises:
collecting at least one diaphragm body automatically by means of a holding device arranged on a second tool slide that is movable relative to the glass assembly held in the workpiece holder; and
inserting the diaphragm body into the aperture by means of the holding device, wherein the holding device and the glass assembly are moved relative to each other to insert the diaphragm body into the aperture.

6. The method of claim 1, wherein the step of forming the aperture through the tube wall of the outer tube comprises:
local melting of the tube wall of the outer tube by means of a first gas burner or laser; and
applying an overpressure in a space at least partially enclosed between the inner tube and the outer tube.

7. The method of claim 1, wherein the glass assembly comprises two inner tubes arranged coaxially, one adjacent the other, inside of the outer tube, and wherein the two inner tubes are substance-to-substance bonded to the outer tube at their ends facing the respective adjacent inner tube.

8. The method according to claim 7, wherein the ends of the outer tube are each held by a workpiece holder of rotatable spindles of a lathe that are opposite each other, and wherein the two inner tubes are connected to the outer tube at a region of the outer tube that is disposed substantially centrally between the ends of the outer tube.

9. The method of claim 8, wherein a first inner tube of the two inner tubes is connected to the outer tube at a first connection point, and a second inner tube is connected to the outer tube at a second connection point that is axially spaced apart from the first connection point with respect to an axis of rotation of the outer tube, and
wherein the forming of the aperture through the tube wall of the outer tube, the introducing of the diaphragm body into the aperture, and the production of a substance-to-substance bond between the diaphragm body and the tube wall of the outer tube are carried out simultaneously at a first position in the tube wall, the first position between the first connection point and a first end of the outer tube, which is the end nearest the first connection point, and at a second position in the tube wall, the second position between the second connection point and a second end of the outer tube, the second end opposite the first end.

10. The method of claim 9, wherein multiple apertures are formed between the first connection point and the first end of the outer tube, a diaphragm body is introduced into each aperture and a substance-to-substance bond each is created between each diaphragm body and the tube wall, and wherein an equal number of apertures are formed between the second connection point and the second end of the outer tube, a diaphragm body introduced into each aperture and a substance-to-substance bond created between each diaphragm body and the tube wall, as between the first connection point and the first end of the outer tube.

11. The method of claim 10, the method further comprising:
after bonding all diaphragm bodies to the tube wall of the outer tube, dividing the glass assembly into two separate glass bodies by means of a dividing flame or by a laser that acts on the outer tube at a location between the first connection point and the second connection point.

12. The method of claim 5, wherein the method is executed by an automatic controller configured to control a drive of a rotational movement of the spindle, one or more drives of the tool slide, one or more gas burners or lasers, and/or one or more drives of the holding device.

13. The method of claim 5, wherein the first tool slide and/or the second tool slide are structured to move orthogonally to the axis of rotation of the spindle.

14. The method of claim 1, wherein the inner tube and the tube wall of the outer tube, and/or the tube wall and at least the portion of the diaphragm body with the coating of glass, are fused together to create the substance-to-substance bond.

15. An apparatus for the automated production of a glass body for a potentiometric sensor, the apparatus comprising:
a lathe with at least one spindle that is rotatable about an axis of rotation and that includes a first workpiece holder;
a heat source mounted on a first tool slide that can be moved relative the axis of rotation of the spindle;
one or more drives embodied to generate rotational movement of the spindle and movement of the first tool slide; and
a controller configured to control the heat source and the one or more drives to perform a method for the automated production of a glass body comprising a diaphragm for a sensor, the method comprising: providing to the lathe a glass assembly that includes an outer tube and at least one inner tube disposed within the outer tube, wherein the inner tube and the outer tube are arranged coaxially and wherein one end of the inner tube is substance-to-substance bonded to a tube wall of the outer tube; forming an aperture through the tube wall of the outer tube using the heat source; introducing a porous diaphragm body into the aperture, at least a portion of the diaphragm body including a coating of glass; and creating a substance-to-substance bond between the tube wall of the outer tube and at least the section of the diaphragm body comprising the coating of glass using the heat source.

16. The apparatus of claim 15, further comprising a holding device embodied to automatically collect one or more diaphragm bodies from a supply of diaphragm bodies, the holding device mounted on a second tool slide that is movable relative to the axis of rotation of the rotatable spindle of the lathe, wherein the controller is designed to control the movement of the second tool slide and the holding device.

17. The apparatus of claim 16, further comprising a second spindle that is rotatable about the axis of rotation and that includes a second workpiece holder, wherein the first and second workpiece holders are arranged opposite each other.

18. The apparatus of claim 16, wherein the first tool slide and/or the second tool slide are structured to move orthogonally to the axis of rotation of the spindle.

19. The apparatus of claim 15, wherein the heat source is one or more gas burners and/or lasers.
